(19) United States
(12) Patent Application Publication
(10) Pub. No.: US 2026/0067731 A1
(43) Pub. Date: Mar. 5, 2026

(54) COMMUNICATION METHOD, APPARATUS AND SYSTEM BASED ON DISTRIBUTED SYSTEM

(71) Applicant: BEIJING XIAOMI MOBILE SOFTWARE CO., LTD., Beijing (CN)

(72) Inventors: Liangang CHI, Beijing (CN); Gaoming DUAN, Beijing (CN)

(73) Assignee: BEIJING XIAOMI MOBILE SOFTWARE CO., LTD., Beijing (CN)

(21) Appl. No.: 19/113,946

(22) PCT Filed: Sep. 26, 2022
(86) PCT No.: PCT/CN2022/121426

§ 371 Date: Mar. 21, 2025

(51) Int. Cl. H04W 24/10; H04B 17/309; H04B 17/318; H04L 5/00

(52) U.S. Cl. CPC H04W 24/10; H04B 17/328; H04B 17/346; H04L 5/0051

(57) ABSTRACT

The embodiments of the present disclosure provide communication methods, communication devices based on a distributed system and a non-transitory computer storage medium. The communication method based on a distributed system performed by a network device comprises: determining measurement configuration information and sending same to a UE, wherein the measurement configuration information comprises a measurement transmission/reception point (TRP) identifier set, a measurement metric and a measurement parameter; sending reference signals of measurement TRPs which correspond to the measurement TRP identifier set; receiving an identifier of a recommended TRP or an identifier of a recommended TRP reference signal, wherein the recommended TRP is a measurement TRP meeting a condition and determined by the UE according to the measurement metric and the measurement parameter; and determining at least one of a transmission TRP or reception TRP for subsequently used, according to the identifier of the recommended TRP or the identifier of the recommended TRP reference signal.

### CROSS-REFERENCE TO RELATED APPLICATIONS

This application is a U.S. National Phase of International Application No. PCT/CN2022/121426, filed with the State Intellectual Property Office of P.R. China on Sep. 26, 2022, the entire contents of which are incorporated herein by reference.

### TECHNICAL FIELD

The disclosure relates to a field of mobile communication technology, in particular to a communication method, apparatus and system based on a distributed system.

### BACKGROUND

With the continuous evolution of mobile network communication technology, the requirements of various application scenarios for supporting the flexible configuration of multiple service types are getting higher and higher. In order to meet communication requirements such as ultra-high rate, ultra-low latency, and ultra-large bandwidth, a distributed multiple input multiple output (MIMO) communication system has emerged. In the distributed MIMO system, cooperative transmission between multiple transmission/reception points (TRPs) is the key to improving system performance. How to select a suitable set of TRPs to serve a user equipment (UE) is a problem to be solved urgently.

### SUMMARY

According to a first aspect of embodiments of the disclosure, a communication method based on a distributed system is provided. The method is performed by a network device, and includes: determining measurement configuration information, in which the measurement configuration information includes a measurement TRP ID set, a measurement metric and a measurement parameter; sending the measurement configuration information to a UE; sending reference signals of measurement TRPs which correspond to the measurement TRP ID set; receiving an ID of a recommended TRP or an ID of a recommended TRP reference signal, in which the recommended TRP is a measurement TRP that meets a condition and determined by the UE according to the measurement metric and the measurement parameter; and determining at least one of a transmission TRP or a reception TRP for subsequent use, according to the ID of the recommended TRP or the ID of the recommended TRP reference signal.

According to a second aspect of embodiments of the disclosure, a communication method based on a distributed system is provided. The method is performed by a UE, and includes: receiving measurement configuration information sent by a network device, in which the measurement configuration information includes a measurement TRP ID set, a measurement metric and a measurement parameter; receiving measurement TRP reference signals of measurement TRPs which correspond to the measurement TRP ID set sent by the network device; determining measurement results of the measurement metrics of the reference signals, and determining a measurement TRP that meets a condition as a recommended TRP according to the measurement results and the measurement parameter; and sending an ID of a recommended TRP or an ID of a recommended TRP reference signal to the network device, in which the recommended TRP is used for assisting the network device to determine at least one of a transmission TRP or a reception TRP for subsequent use.

According to a third aspect of embodiments of the disclosure, a communication device is provided. The communication device includes: a transceiver, a memory and a processor connected to the transceiver and the memory, respectively. The processor is configured to: determine measurement configuration information, wherein the measurement configuration information comprises a measurement transmission/reception point (TRP) identifier (ID) set, a measurement metric and a measurement parameter; send the measurement configuration information to a user equipment (UE); send reference signals of measurement TRPs which correspond to the measurement TRP ID set; receive an ID of a recommended TRP or an ID of a recommended TRP reference signal, wherein the recommended TRP is a measurement TRP meeting a condition and determined by the UE according to the measurement metric and the measurement parameter; and determine at least one of a transmission TRP or a reception TRP for subsequent use, according to the ID of the recommended TRP or the ID of the recommended TRP reference signal.

### BRIEF DESCRIPTION OF THE DRAWINGS

The above and/or additional aspects and advantages of the disclosure will be apparent and easily understood from the following descriptions of the embodiments in combination with the accompanying drawings, in which:

FIG. 1 is a flowchart of a communication method based on a distributed system according to an embodiment of the disclosure.

FIG. 2 is a flowchart of a communication method based on a distributed system according to an embodiment of the disclosure.

FIG. 3 is a flowchart of a communication method based on a distributed system according to an embodiment of the disclosure.

FIG. 4 is a flowchart of a communication method based on a distributed system according to an embodiment of the disclosure.

FIG. 5 is a schematic diagram of signaling interaction in a communication method based on a distributed system according to an embodiment of the disclosure.

FIG. 6 is a schematic diagram of a communication apparatus based on a distributed system according to an embodiment of the disclosure.

FIG. 7 is a schematic diagram of a communication apparatus based on a distributed system according to an embodiment of the disclosure.

FIG. 8 is a schematic diagram of a communication apparatus based on a distributed system according to an embodiment of the disclosure.

FIG. 9 is a schematic diagram of a communication device according to an embodiment of the disclosure.

FIG. 10 is a schematic diagram of a chip according to an embodiment of the disclosure.

### DETAILED DESCRIPTION

The embodiments of the disclosure will be described in detail, examples of which are illustrated in the accompanying drawings, in which the same or similar numbers indicate the same or similar elements or elements having the same or similar functions throughout. The embodiments described below with reference to the accompanying drawings are exemplary and are intended to explain the disclosure, and should not be construed as limiting the disclosure.

The boundaries of application scenarios of mobile network communication technology in real life are constantly expanding. For example, with the emergence of new application scenarios, such as future-oriented augmented reality (AR), virtual reality (VR), and new Internet applications (such as Internet of Vehicles, Internet of Things), the application scenarios have increasingly higher requirements for network communication rate, latency, bandwidth and other capabilities.

In specific application scenarios, different service types have different requirements for wireless communication technologies. For example, the requirement for an enhanced Mobile Broad Band (eMBB) service focuses on large bandwidth and high rate, the requirement for an ultra reliable low latency communication (URLLC) service focuses on higher reliability and low latency, and the requirement for a massive Machine Type Communication (mMTC) service focuses on the massive number of connections. It can be seen that the new generation wireless communication system asks for more flexible and configurable designs to meet the transmission requirements for various service types.

In order to meet the communication requirements such as ultra-high speed, ultra-low latency and ultra-large bandwidth, MIMO technology has opened a new era for development and utilization of space resources of mobile communication systems. Distributed MIMO is developed on the basis of traditional classic MIMO technology and extends the application scope of traditional MIMO. Not only can it be applied to a single-cell cellular base station system, but it can also further replace a multi-cell cellular base station to form a cellular-free mobile communication system in the form of distributed MU-MIMO, which is cellfree technology. Cellfree can provide services for all UEs with the same time-frequency resources, without the need for traditional inter-cell frequency division, and the system resources can be dynamically scheduled in all aspects, which can improve the flexibility of the existing system resource allocation and greatly improve the utilization rate of resources.

By adopting the distributed MIMO technology, the terminal can be served by multiple base stations at the same time, and there will be no cell switching. Without the concept of cell boundary, the user experience will be smoother. Since one UE is served by multiple TRPs, better signal quality is guaranteed, which can meet the high-speed and high-capacity service requirements of the UE.

In the distributed MIMO system, cooperative transmission between multiple TRPs is the key to improve the system performance, and how to choose an appropriate set of TRPs to serve the terminal is a problem to be solved urgently.

Therefore, the disclosure proposes a communication method based on a distributed system, a communication apparatus based on a distributed system and a system, to solve the problem of multi-TRP cooperative transmission in the distributed MIMO. By selecting some appropriate TRPs in a multi-TRP set as serving nodes for adapting to a cyclic prefix (CP) of a UE, the UE can be served by using multiple TRPs, which improves a signal reception quality of the UE.

It can be understood that the scheme provided by this disclosure can be used for the Fifth Generation (5G) mobile communication technology and its future communication technologies, such as 5G-advanced mobile communication technology and the Sixth Generation (6G) mobile communication technology, which is not limited in this disclosure.

The communication method based on a distributed system and the communication apparatus based on a distributed system provided by this disclosure will be introduced in detail in combination with the attached drawings.

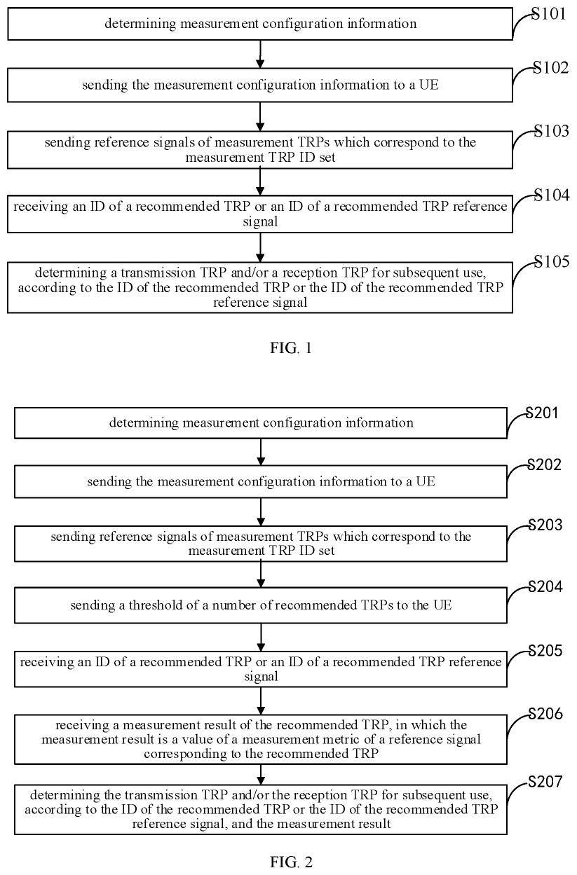

FIG. 1 is a flowchart of a communication method based on a distributed system according to an embodiment of the disclosure. The method is performed by a network device. In the embodiment of the disclosure, the network device can be understood as a base station. In detail, it is understood as a next Generation Node B (gNB) in a 5G communication scenario.

As illustrated in FIG. 1, the method includes the following steps.

At step S101, measurement configuration information is determined.

In the embodiment of the disclosure, the measurement configuration information includes a measurement TRP ID set, a measurement metric and a measurement parameter. The network device can configure the measurement configuration information, including configuring the measurement TRP ID set, configuring the measurement metric, and configuring the measurement parameter.

At step S102, the measurement configuration information is sent to a UE.

In an implementation of the disclosure, the measurement TRP ID set includes at least one of IDs of the measurement TRPs, or resource IDs and/or sequence IDs of the reference signals of the measurement TRP references.

In an implementation of the disclosure, the measurement metric is understood as a type of reference signal to be measured, including at least one of a SINR, a RSRP, a RSRQ or a RSSI.

In an implementation of the disclosure, the measurement parameter includes a range of arrival time and a reference signal quality threshold. The range of arrival time is a range within which an arrival time of the recommended TRP should fall, and the arrival time includes a single-path arrival time or a multi-path arrival time. The network device may configure a value for the time, such as 5 s, to assist a UE in deciding a TRP that meets the condition, e.g., a TRP whose arrival time falls within a configured range of the value for the time.

The reference signal quality threshold is the minimum value that a receiving energy of the measurement TRP reference signal at the UE should meet. The network device may configure a threshold for the above measurement metric to assist the UE in deciding a TRP that meets the condition. For example, the network device indicates to the UE that the measurement metric is RSRP and the reference signal quality threshold is −80 dBm, so that the UE can select the TRP whose reference signal meets the condition.

At step S103, reference signals of measurement TRPs which correspond to the measurement TRP ID set is sent.

The network device sends the reference signals of measurement TRPs which corresponding to the measurement TRP ID set to the UE for measurement of the UE.

At step S104, an ID of a recommended TRP or an ID of a recommended TRP reference signal is received.

In the embodiment of the disclosure, the recommended TRP is a measurement TRP that meets the condition determined by the UE according to the measurement metric and the measurement parameter.

As mentioned above, the UE can select the TRP that meets the condition as the recommended TRP according to an indication of the network device, and send the ID of the recommended TRP or the ID of the recommended TRP reference signal to the network device.

At step S105, a transmission TRP and/or a reception TRP that is subsequent used is determined according to the ID of the recommended TRP or the ID of the recommended TRP reference signal.

In the embodiment of the disclosure, according to the ID of the recommended TRP sent by the UE, the network device may select an appropriate TRP as a transmission TRP and/or a reception TRP for transmitting and receiving signals in subsequent use. It is understood that the principle for the network device to determine the transmission TRP and/or the reception TRP for subsequent use can be: ensuring a maximum overall energy efficiency in the situation of multiple users.

In conclusion, according to the method of the disclosure, the network device may determine and send the measurement configuration information to the UE, which includes a measurement TRP ID set, a measurement metric and a measurement parameter. The network device may also send the reference signals of measurement TRPs which correspond to the measurement TRP ID set, and receives the ID of the recommended TRP or the ID of the recommended TRP reference signal, in which the recommended TRP is the measurement TRP that meets the condition determined by the UE according to the measurement metric and the measurement parameter. It determines the transmission TRP and/or the reception TRP for subsequent use, according to the ID of the recommended TRP or the ID of the recommended TRP reference signal. The scheme proposed in this disclosure solves the problem of cooperative transmission of multiple TRPs in the distributed MIMO. By selecting some appropriate TRPs in a multi-TRPs set as serving nodes for adapting a CP of a UE, the signal reception quality of the UE is improved by serving the UE through the multi-TRPs.

FIG. 2 is a flowchart of a communication method based on a distributed system according to an embodiment of the disclosure. The method is performed by a network device. Based on the embodiment of FIG. 1, as illustrated in FIG. 2, the method includes the following steps.

At step S201, measurement configuration information is determined.

The network device can configure the measurement configuration information, including configuring a measurement TRP ID set, configuring a measurement metric, and configuring a measurement parameter.

In detail, there are several ways to configure the measurement TRP set: 1) configuring measurement TRP IDs; 2) configuring resource IDs of reference signals of themeasurement TRPs; 3) configuring sequence IDs of reference signals of the measurement TRPs.

The network device may configure the measurement metric, including any one of a RSRP, a RSRQ, a SINR, and a RSSI. The network device can also configure the measurement parameter such as a range of arrival time and a reference signal quality threshold. As described in the embodiment of FIG. 1, details are omitted here.

In some optional embodiments, the network device may also configure a type and/or a length of a reference CP, which will not be described in detail in this disclosure.

At step S202, the measurement configuration information is sent to a UE.

At step S203, reference signals of measurement TRPs which correspond to the measurement TRP ID set is sent.

For the descriptions of the above steps 201-S203, reference may be made to the descriptions of steps S101-S103 in the embodiment shown in FIG. 1.

At step S204, a threshold of a number of recommended TRPs is sent to the UE.

In the embodiment of the disclosure, the network device may indicate to the UE the threshold of the number of recommended TRPs, i.e., the maximum number of TRPs reported. The UE may report a number of TRP IDs less than or equal to the threshold according to the indication of the network device.

It should be understood that step S204 is an optional step, and it may be performed at any time before receiving an ID of a recommended TRP or an ID of a recommended TRP reference signal, which is not limited in the disclosure.

At step S205, an ID of a recommended TRP or an ID of a recommended TRP reference signal is received.

In the embodiment of the disclosure, the recommended TRP is a TRP that meets a condition determined by the UE according to the configuration of the network device, for example, a TRP that meets the condition of a range of arrival time or a reference quality signal threshold indicated by the network device. In some optional embodiments, the number of recommended TRPs can be determined based on the indication of the network device, or the UE may report all recommended TRPs.

At step S206, a measurement result of the recommended TRP is received, in which the measurement result is a value of a measurement metric of a reference signal corresponding to the recommended TRP.

In some optional embodiments of the disclosure, in addition to receiving the ID of the recommended TRP or the ID of the recommended TRP reference signal, the network device may also receive the measurement result of the recommended TRP. For example, the UE determines the corresponding measurement result of the measurement metric, that is, the measurement value, by measuring the measurement TRP reference signal, and reports the measurement result together with the ID of the recommended TRP or the ID of the recommended TRP reference signal to the network device.

It can be understood that step S206 is an optional step, and it can be performed simultaneously with step S205, or separately, and its execution sequence is not limited in the disclosure.

At step S207, a transmission TRP and/or a reception TRP for subsequent use are determined according to the ID of the recommended TRP or the ID of the recommended TRP reference signal and the measurement result.

In the embodiment of the disclosure, the network device may determine a suitable TRP for transmitting and receiving subsequent signals according to the ID of the recommended TRP or the ID of the recommended TRP reference signal and the corresponding measurement result reported by the UE.

In conclusion, according to the method of the disclosure, the network device determines and sends the measurement configuration information to the UE, which includes a measurement TRP ID set, a measurement metric and a measurement parameter. The network device also sends reference signals of measurement TRPs which correspond to the measurement TRP ID set, and receives the ID of the recommended TRP or the ID of the recommended TRP reference signal, in which the recommended TRP is the measurement TRP that meets the condition determined by the UE according to the measurement metric and the measurement parameter. It determines a transmission TRP and/or a reception TRP for subsequent use, according to the ID of the recommended TRP or the ID of the recommended TRP reference signal. The scheme proposed in this disclosure solves the problem of cooperative transmission of multiple TRPs in the distributed MIMO, and improves the signal reception quality of the UE by selecting a suitable portion of the TRPs in the multiple TRPs set as a service node to be used to adapt the CP of the UE, and by serving the UE through the multiple TRPs. The network device in the disclosure may also indicate a maximum number of TRPs reported to the UE, to optimize communication performance and resource allocation and to reduce waste. The network device in the disclosure may also receive a measurement result reported by the UE, and make a decision according to the measurement result, further improving accuracy.

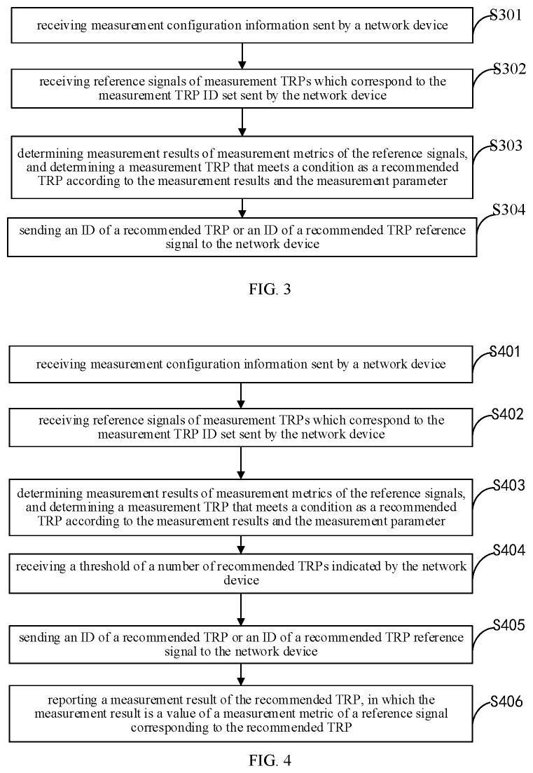

FIG. 3 is a flowchart of a communication method based on a distributed system according to an embodiment of the disclosure. The method is performed by a UE. The UE includes, but is not limited to, a smart terminal, a cellular phone, a wireless device, a handset, a mobile unit, a vehicle, a vehicle-mounted device, etc.

As illustrated in FIG. 3, the method includes the following steps.

At step S301, measurement configuration information sent by a network device is received.

In the embodiment of the disclosure, the measurement configuration information includes a measurement TRP ID set, a measurement metric and a measurement parameter.

In an implementation of the disclosure, the measurement TRP ID set includes at least one of IDs of the measurement TRPs or resource IDs and/or sequence IDs of the reference signals of the measurement TRPs.

In an implementation of the disclosure, the measurement metric is understood as a type of a reference signal to be measured, including at least one of a SINR, a RSRP, a RSRQ or a RSSI.

In an implementation of the disclosure, the measurement parameter includes a range of arrival time and a reference signal quality threshold. The range of arrival time is a range within which an arrival time of the recommended TRP should fall, and the arrival time includes a single-path arrival time or a multi-path arrival time. The network device can configure a time, such as 5 s, to assist a UE in deciding a TRP that meets the condition, e.g., a TRP whose arrival time falls within a configured range of the time.

The reference signal quality threshold is the minimum value that a receiving energy of the measurement TRP reference signal at the UE should meet. The network device can configure a threshold for the above measurement metric to assist the UE in deciding a TRP that meets the condition. For example, the network device indicates to the UE that the measurement metric is a RSRP and the reference signal quality threshold is −80 dBm, so that the UE may select the TRP whose reference signal meets the condition.

At step S302, reference signals of measurement TRPs which correspond to the measurement TRP ID set sent by the network device is received.

In the embodiment of the disclosure, the UE may receive the measurement TRP reference signal sent by the network device and measure it.

At step S303, measurement results of measurement metrics of the reference signals are determined, and a measurement TRP that meets a condition is determined as a recommended TRP according to the measurement results and the measurement parameter.

In the embodiment of the disclosure, the UE receives the configuration information of the network device, which includes the measurement metric and the measurement parameter. For the measurement TRP reference signal sent by the network device, the UE may determine the measurement results of the measurement metrics of the reference signals, and compare the measurement results with the measurement parameter indicated by the network device, to determine the measurement TRP that meets the condition as the recommended TRP.

At step S304, an ID of a recommended TRP or an ID of a recommended TRP reference signal is sent to the network device.

In the embodiment of the disclosure, the UE sends the ID of the recommended TRP or the ID of the recommended TRP reference signal to the network device to assist the network device in determining a transmission TRP and/or reception TRP for subsequent use.

In conclusion, according to the method of the disclosure, the UE receives the measurement configuration information sent by the network device, which includes a set of measurement TRP IDs, a measurement metric and a measurement parameter. The UE also receives reference signals of measurement TRPs which correspond to the measurement TRP ID set sent by the network device, determines measurement results of the measurement metrics of the reference signals, and determines the measurement TRP that meets the condition as the recommended TRP according to the measurement result and the measurement parameter. The UE sends the ID of the recommended TRP or the ID of the recommended TRP reference signal to the network device, in which the recommended TRP is used for assisting the network device to determine a transmission TRP and/or a reception TRP for subsequent use. The scheme proposed in this disclosure solves the problem of cooperative transmission of multiple TRPs in the distributed MIMO and improves the signal reception quality of the UE by selecting a suitable portion of the TRPs in the set of multiple TRPs as a service node to be used to adapt the CP of the UE, and by serving the UE through the multiple TRPs.

FIG. 4 is a flowchart of a communication method based on a distributed system according to an embodiment of the disclosure. As illustrated in FIG. 4, the method is performed by a UE. Based on the embodiment of FIG. 3, the method includes the following steps.

At step S401, measurement configuration information sent by a network device is received.

At step S402, reference signals of measurement TRPs which correspond to the measurement TRP ID set sent by the network device is received.

The principles of the above steps S401-S402 are the same as those of the steps S301-S302 in the embodiment shown in FIG. 3, which can be referred to the descriptions of the above embodiments and will not be repeated here.

At step S403, measurement results of a measurement metricsy of the reference signals are determined, and a measurement TRP that meets a condition is determined as a recommended TRP according to the measurement results and a measurement parameter.

In detail, step S403 includes: determining values of the measurement metrics of the reference signals as the measurement results; and determining the measurement TRP that meets the condition as the recommended TRP according to the measurement results and the measurement parameter.

The UE receives the measurement configuration information from the network device, which includes a measurement metric and a measurement parameter. The UE may measure the received reference signals. For example, the measurement metric indicated by the network device is a RSRP, and the measurement parameter includes a range of arrival time and a reference signal quality threshold, if the range of arrival time is 5 s and the reference signal quality threshold is −80 dBm, the UE may determine the TRP that meets the condition as the recommended TRP.

The UE may determine the measurement TRP whose arrival time of the reference signal at the UE falls within the range of arrival time as a candidate TRP.

For example, the set of measurement TRP IDs indicated by the network device includes TRP 1, TRP 2 and TRP 3. Measurement TRPs may reach the UE through multiple paths. For example, TRP 1 corresponds to one path, TRP 2 corresponds to three paths and TRP 3 corresponds to five paths. The UE takes the TRP whose arrival time falls within the range of arrival time of 5 s indicated by the network device as a candidate TRP. The arrival time of the reference signal includes a single-path arrival time or a multi-path arrival time. In other words, if the measurement TRP corresponds to multiple paths, and the arrival times of the multiple paths for the TRP all falls within the range of arrival time, the TRP can be determined as the recommended TRP.

It should be understood that the range of arrival time indicated by the network device to the UE can be understood as a sliding time period, which means that the network device only indicates a length of the range of arrival time without indicating a start time and an end time of the range of arrival time. The way for the UE to determine the start time and the end time of the time of arrival range is no limited here and it depends on the specific application situation.

In the embodiment of the disclosure, the UE may determine the candidate TRP whose measurement result is greater than or equal to the reference signal quality threshold as a recommended TRP. For example, in the above example in the disclosure, the measurement metric indicated by the network device is a RSRP, and the reference signal quality threshold is −80 dBm, when the UE determines that the RSRP value corresponding to the candidate TRP is −60 dBm, the candidate TRP may be used as the recommended TRP.

At step S404, a threshold of a number of recommended TRPs indicated by the network device is received.

In the embodiment of the disclosure, the UE may receive the threshold of the number of recommended TRPs indicated by the network device, i.e., the maximum number of TRPs reported. When the number of recommended TRPs determined by the UE is greater than the indicated threshold, the UE may select and report a number of recommended TRPs that is less than or equal to the threshold indicated by the network device according to certain selection principles.

It can be understood that step S404 is an optional step, and its execution sequence is not limited in the disclosure.

At step S405, an ID of the recommended TRP or an ID of the recommended TRP reference signal is sent to the network device.

In the embodiment of the disclosure, the UE reports the ID of the recommended TRP or the ID of the recommended TRP reference signal to the network device to assist the network device in determining a transmission TRP and/or a reception TRP for subsequent use.

At step S406, the measurement result of the recommended TRP is reported, in which the measurement result is the value of the measurement metric of the reference signal corresponding to the recommended TRP.

In the embodiment of the disclosure, the UE may also report the measurement result of the recommended TRP to the network device. For example, the UE determines the corresponding measurement result of the measurement metric, i.e., the measurement value, by measuring the reference signal of the measurement TRP, and reports the measurement result together with the ID of the recommended TRP or the ID of the recommended TRP reference signal to the network device, such as −60 dBm in the example above.

It can be understood that step S406 is an optional step, and it can be performed simultaneously with step S405, or separately, and its execution sequence is not limited in the disclosure.

In conclusion, according to the method of the disclosure, the UE receives the measurement configuration information sent by the network device, which includes a measurement TRP ID set, a measurement metric and a measurement parameter. The UE also receives reference signals of measurement TRPs which correspond to the measurement TRP ID set sent by the network device, determines the measurement result of the measurement metric of the reference signal, and determines the measurement TRP that meets the condition as the recommended TRP according to the measurement result and the measurement parameter. The UE sends the ID of the recommended TRP or the ID of the recommended TRP reference signal to the network device, in which the recommended TRP is used for assisting the network device to determine the transmission TRP and/or the reception TRP for subsequent use. The scheme proposed in this disclosure solves the problem of cooperative transmission of multiple TRPs in the distributed MIMO, and improves the signal reception quality of the UE by selecting a suitable portion of the TRPs in the set of multiple TRPs as a service node to be used to adapt the CP of the UE, and by serving the UE through the multiple TRPs. The UE in the disclosure may also receive the maximum number of TRPs reported sent by the network device, to optimize a communication performance and a resource allocation and to reduce waste. The UE in the disclosure may also sent a measurement result to the network device, to assist the network device in making a decision according to the measurement result, which further improves the accuracy.

FIG. 5 is a flowchart of a communication method based on a distributed system according to an embodiment of the disclosure. The method is performed by a communication system. The communication system includes a network device and a UE. As illustrated in FIG. 5, the method includes the following steps.

At step S501, the network device determines measurement configuration information, in which the measurement configuration information includes a set of measurement TRP IDs, a measurement metric and a measurement parameter.

At step S502, the network device sends the measurement configuration information to the UE.

At step S503, the network device sends reference signals of measurement TRPs which correspond to the measurement TRP ID set to the UE.

At step S504, the UE determines measurement results of the measurement metrics of the reference signals, and determines a measurement TRP that meets a condition as a recommended TRP according to the measurement results and the measurement parameter.

At step S505, the UE sends an ID of the recommended TRP or an ID of the recommended TRP reference signal to the network device.

At step S506, the network device determines a transmission TRP and/or a reception TRP for subsequent use, according to the ID of the recommended TRP or the ID of the recommended TRP reference signal.

The principles of the above steps S501-S506 are the same as those of the embodiments shown in FIGS. 1-4, which can be referred to the above embodiments, and will not repeated here.

In conclusion, according to the method of the disclosure, the network device determines and sends the measurement configuration information to the UE, which includes a measurement TRP ID set, a measurement metric and a measurement parameter. The network device also sends reference signals of measurement TRPs which correspond to the measurement TRP ID set, and receives an ID of a recommended TRP or an ID of a recommended TRP reference signal, in which the recommended TRP is the measurement TRP that meets the condition determined by the UE according to the measurement metric and the measurement parameter. It determines a transmission TRP and/or a reception TRP for subsequent use, according to the ID of the recommended TRP or the ID of the recommended TRP reference signal. The scheme proposed in this disclosure solves the problem of cooperative transmission of multiple TRPs in distributed MIMO, and improves the signal reception quality of the UE by selecting a suitable portion of the TRPs in the set of multiple TRPs as a service node to be used to adapt the CP of the UE, and by serving the UE through the multiple TRPs.

In the above embodiments of the disclosure, the methods provided by the embodiments of the disclosure are introduced from the perspectives of the UE side and the network device side respectively. In order to realize the functions in the methods provided by the embodiments of the disclosure, the UE and the network device may include a hardware structure and a software module, and the above functions are realized in the form of the hardware structure, the software module, or a combination of the hardware structure and the software module. A certain function of the above functions can be implemented in a hardware structure, a software module, or a combination of the hardware structure and the software module.

Corresponding to the communication methods based on the distributed system provided in the above embodiments, the disclosure also provides the communication apparatuses based on the distributed system. Since the communication apparatuses based on the distributed system provided in the embodiments of the disclosure correspond to the communication methods based on the distributed system provided in the above embodiments, the implementations of the communication methods based on the distributed system are also applicable to the communication apparatuses based on the distributed system provided in the embodiments, and will not be described in detail in the following embodiments.

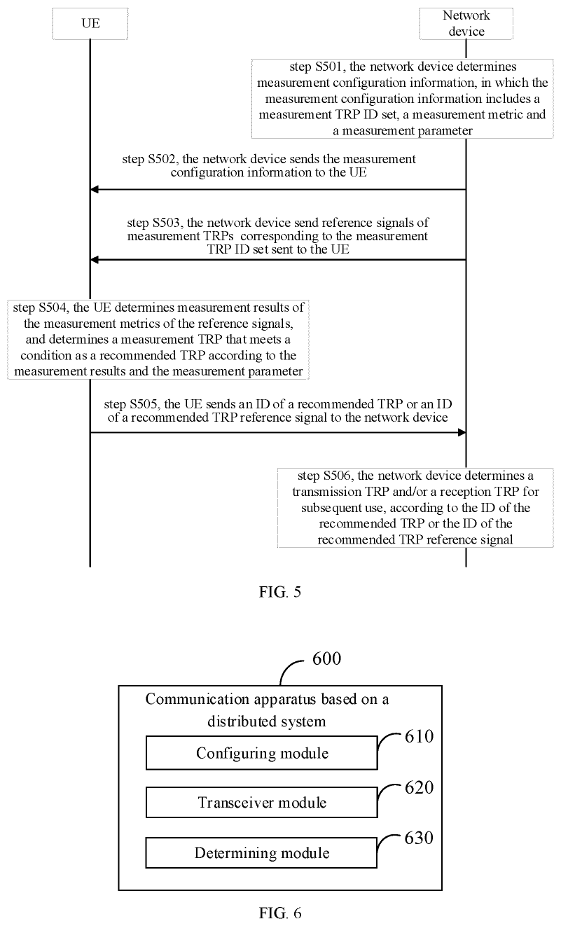

FIG. 6 is a schematic diagram of a communication apparatus 600 based on a distributed system provided by an embodiment of the disclosure. The communication apparatus 600 can be applied to a network device.

As illustrated in FIG. 6, the apparatus 600 includes: a configuring module 610, configured to determine measurement configuration information, in which the measurement configuration information includes a measurement TRP ID set, a measurement metric and a measurement parameter; a transceiver module 620, configured to send the measurement configuration information to a UE; send reference signals of measurement TRPs which correspond to the measurement TRP ID set; and receive an ID of a recommended TRP or an ID of a recommended TRP reference signal, in which the recommended TRP is a measurement TRP that meets a condition determined by the UE according to the measurement metric and the measurement parameter; and a determining module 630, configured to determine a transmission TRP and/or a reception TRP for subsequent use, according to the ID of the recommended TRP or the ID of the recommended TRP reference signal.

In conclusion, according to the apparatus of the disclosure, the network device determines and sends the measurement configuration information to the UE, which includes a measurement TRP ID set, a measurement metric and a measurement parameter. The network device also sends reference signals of measurement TRPs which correspond to the measurement TRP ID set, and receives an ID of a recommended TRP or an ID of a recommended TRP reference signal, in which the recommended TRP is the measurement TRP that meets the condition determined by the UE according to the measurement metric and the measurement parameter. It determines the sending TRP and/or the receiving TRP for subsequent use, according to the ID of the recommended TRP or the ID of the recommended TRP reference signal. The scheme proposed in this disclosure solves the problem of cooperative transmission of multiple TRPs in distributed MIMO, and improves the signal reception quality of the UE by selecting a suitable portion of the TRPs in the set of multiple TRPs as a service node to be used to adapt the CP of the UE, and by serving the UE through the multiple TRPs.

In some embodiments, the measurement TRP ID set includes at least one of IDs of the measurement TRPs or resource IDs and/or sequence IDs of reference signals corresponding to the measurement TRPs.

In some embodiments of the disclosure, the measurement metric includes at least one of a SINR, a RSRP, a RSRQ or a RSSI. The measurement parameter includes a range of arrival time and a reference signal quality threshold.

In some embodiments of the disclosure, the range of arrival time is a range within which an arrival time of the recommended TRP should fall, and the arrival time includes a single-path arrival time or a multi-path arrival time.

In some embodiments, the reference signal quality threshold is the minimum value that a receiving energy of the measurement TRP reference signal at the UE should meet.

In some embodiments, the transceiver module 620 is further configured to:
receive a measurement result of the recommended TRP, in which the measurement result is a value of a measurement metric of a reference signal corresponding to the recommended TRP.

In some embodiments, the determining module 630 is further configured to:
determine a transmission TRP and/or a reception TRP for subsequent use, according to the ID of the recommended TRP or the ID of the recommended TRP reference signal, and the measurement result.

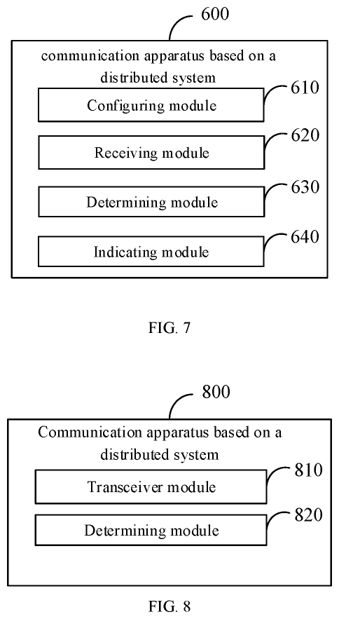

In some embodiments, as illustrated in FIG. 7, the apparatus 600 also includes: an indicating module 640, configured to indicate a threshold of a number of recommended TRPs to the UE.

In conclusion, according to the apparatus of the disclosure, the network device determines and sends the measurement configuration information to the UE, which includes a measurement TRP ID set, a measurement metric and a measurement parameter. The network device also sends reference signals of measurement TRPs which correspond to the measurement TRP ID set, and receives the ID of the recommended TRP or the ID of the recommended TRP reference signal, in which the recommended TRP is the measurement TRP that meets the condition determined by the UE according to the measurement metric and the measurement parameter. It determines the transmission TRP and/or the reception TRP for subsequent use, according to the ID of the recommended TRP or the ID of the recommended TRP reference signal. The scheme proposed in this disclosure solves the problem of cooperative transmission of multiple TRPs in distributed MIMO, and improves the signal reception quality of the UE by selecting a suitable portion of the TRPs in the set of multiple TRPs as a service node to be used to adapt the CP of the UE, and by serving the UE through the multiple TRPs. The network device in the disclosure may also indicate the maximum number of TRPs reported to the UE, to optimize communication performance and resource allocation and to reduce waste. The network device in the disclosure may also receive the measurement result reported by the UE, and make a decision according to the measurement result, which further improves the accuracy.

FIG. 8 is a schematic diagram of a communication apparatus 800 based on a distributed system provided by an embodiment of the disclosure. The communication apparatus 800 can be applied to a UE.

As illustrated in FIG. 8, the apparatus 800 includes: a transceiver module 810, configured to receive measurement configuration information sent by a network device, in which the measurement configuration information includes a measurement TRP ID set, a measurement metric and a measurement parameter; and receive reference signals of measurement TRPs which correspond to the measurement TRP ID set sent by the network device; a determining module 820, configured to determine a measurement result of the measurement metric of the reference signal, and determine a measurement TRP that meets a condition as a recommended TRP according to the measurement result and the measurement parameter; and the transceiver module 810, further configured to send an ID of a recommended TRP or an ID of a recommended TRP reference signal to the network device, in which the recommended TRP is used for assisting the network device to determine a transmission TRP and/or a reception TRP for subsequent use.

According to the apparatus of the disclosure, the UE receives the measurement configuration information sent by the network device, which includes a measurement TRP ID set, a measurement metric and a measurement parameter. The UE also receives the reference signals of measurement TRPs which correspond to the measurement TRP ID set sent by the network device, determines the measurement result of the measurement metric of the reference signal, and determines the measurement TRP that meets the condition as the recommended TRP according to the measurement result and the measurement parameter. The UE sends the ID of the recommended TRP or the ID of the recommended TRP reference signal to the network device, in which the recommended TRP is used for assisting the network device to determine the sending TRP and/or the receiving TRP for subsequent use. The scheme proposed in this disclosure solves the problem of cooperative transmission of multiple TRPs in distributed MIMO, and improves the signal reception quality of the UE by selecting a suitable portion of the TRPs in the set of multiple TRPs as a service node to be used to adapt the CP of the UE, and by serving the UE through the multiple TRPs.

In some embodiments, the determining module 820 is further configured to:
determine values of measurement metrics of the reference signals as the Measurement results; and
determine the measurement TRP that meets the condition as the recommended TRP according to the measurement results and the measurement parameter.

In some embodiments, the measurement parameter includes a range of arrival time and a reference signal quality threshold. A measurement TRP whose arrival time of a reference signal at the UE falls within a range of arrival time is determined as a candidate TRP, and a candidate TRP whose measurement result is greater than or equal to the reference signal quality threshold is determined as the recommended TRP.

In some embodiments, the transceiver module 810 is further configured to:
report a measurement result of the recommended TRP, in which the measurement result is the value of a measurement metric of a reference signal corresponding to the recommended TRP.

In some embodiments, the transceiver module 810 is further configured to:
receive a threshold of a number of recommended TRPs indicated by the network device.

In some embodiments, the determining module 820 is further configured to:
when the number of recommended TRPs is greater than the threshold, select a number of recommended TRPs that is less than or equal to the threshold according to the measurement result of the recommended TRP, and send an ID of the selected recommended TRP or an ID of the recommended TRP reference signal to the network device.

In conclusion, according to the apparatus of the disclosure, the UE receives the measurement configuration information sent by the network device, which includes a measurement TRP ID set, a measurement metric and a measurement parameter. The UE also receives the reference signals of measurement TRPs which correspond to the measurement TRP ID set sent by the network device, determines the measurement result of the measurement metric of the reference signal, and determines the measurement TRP that meets the condition as the recommended TRP according to the measurement result and the measurement parameter. The UE sends the ID of the recommended TRP or the ID of the recommended TRP reference signal to the network device, in which the recommended TRP is used for assisting the network device to determine the transmission TRP and/or the reception TRP for subsequent use. The scheme proposed in this disclosure solves the problem of cooperative transmission of multiple TRPs in distributed MIMO, and improves the signal reception quality of the UE by selecting a suitable portion of the TRPs in the set of multiple TRPs as a service node to be used to adapt the CP of the UE, and by serving the UE through the multiple TRPs. The UE in the disclosure may also receive the maximum number of TRPs reported sent by the network device, to optimize communication performance and resource allocation and to reduce waste. The UE in the disclosure may also sent the measurement result to the network device, to assist the network device in making a decision according to the measurement result, which further improves the accuracy.

The embodiment of the disclosure also provides a communication system. The system includes the communication apparatuses based on the distributed system as shown in the embodiments of FIGS. 6-8, and is used for executing the communication methods based on the distributed system as shown in the embodiments of FIGS. 1-5.

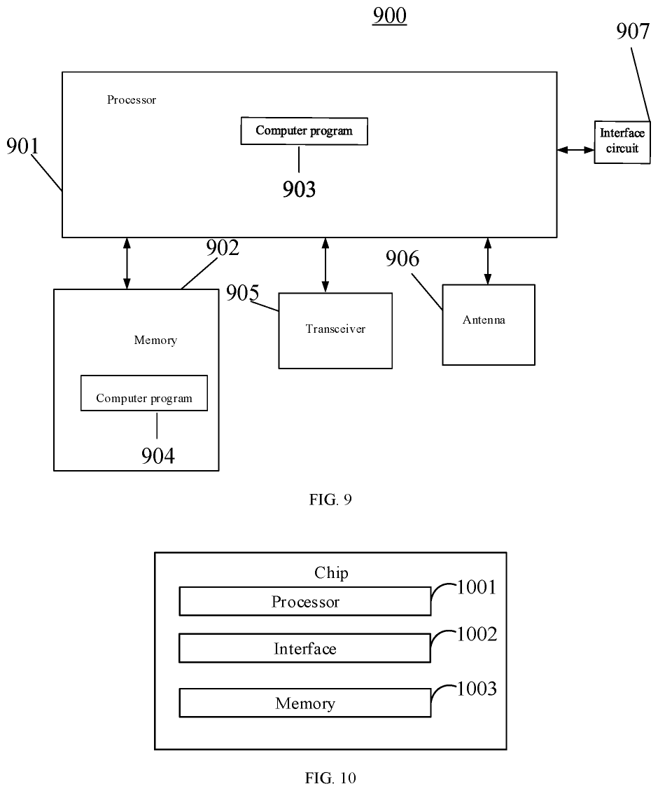

FIG. 9 is a schematic diagram of a communication device 900 provided by an embodiment of the disclosure. The communication device 900 may be a network device, a UE, or a chip, a chip system or a processor that supports the network device to realize the above-described methods, or a chip, a chip system or a processor that supports the UE to realize the above-described methods. The device may be used to realize the methods described in the above method embodiments with reference to the descriptions of the above-described method embodiments.

The communication device 900 may include one or more processors 901. The processor 901 may be a general purpose processor or a dedicated processor, such as, a baseband processor or a central processor. The baseband processor is used for processing communication protocols and communication data. The central processor is used for controlling the communication device (e.g., base station, baseband chip, terminal, terminal chip, central unit (CU) and distributed unit (DU)), executing computer programs, and processing data of the computer programs.

Optionally, the communication device 900 may further include one or more memories 902 on which a computer program 904 may be stored. When the processor 901 executes the computer program 904, the communication device 900 is caused to perform the methods described in the above method embodiments. Optionally, data may also be stored in the memory 902. The communication device 900 and the memory 902 may be provided separately or may be integrated together.

Optionally, the communication device 900 may also include a transceiver 905 and an antenna 906. The transceiver 905 may be referred to as transceiver unit, transceiver machine, or transceiver circuit, for realizing the transceiver function. The transceiver 905 may include a receiver and a transmitter. The receiver may be referred to as receiver machine or receiving circuit, for realizing the receiving function. The transmitter may be referred to as transmitter machine or transmitting circuit, for realizing the transmitting function.

Optionally, the communication device 900 may also include one or more interface circuits 907. The interface circuits 907 are used to receive code instructions and transmit them to the processor 901. The processor 901 runs the code instructions to cause the communication device 900 to perform the methods described in the method embodiments.

In an implementation, the processor 901 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor 901 may store a computer program 903 that can be executed by the processor 901 and may cause the communication device 900 to perform the methods described in the method embodiments above. The computer program 903 may be solidified in the processor 901, in which case the processor 901 may be implemented by hardware.

In an implementation, the communication device 900 may include circuits. The circuits may implement the sending, receiving or communicating function in the preceding method embodiments. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver can also be produced using various IC process technologies, such as complementary metal oxide semiconductor (CMOS), metal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the descriptions of the above embodiments may be a network device or a UE, but the scope of the communication device described in the disclosure is not limited thereto, and the structure of the communication device may not be limited by FIG. 9. The communication device may be a stand-alone device or may be part of a larger device. For example, the described communication device may be:

(1) a stand-alone IC, chip, chip system or subsystem;

(2) a collection of ICs including one or more ICs, optionally, the collection of ICs may also include storage components for storing data and computer programs;

(3) an ASIC, such as a modem;

(4) modules that can be embedded within other devices;

(5) receivers, terminals, smart terminals, cellular phones, wireless devices, handheld machines, mobile units, in-vehicle devices, network devices, cloud devices, artificial intelligence devices, and the like; and

(6) others.

The case that the communication device is a chip or a chip system can be referred to the schematic diagram of the chip shown in FIG. 10. The chip shown in FIG. 10 includes a processor 1001 and an interface 1002. There may be one or more processors 1001, and there may be multiple interfaces 1002.

Optionally, the chip further includes a memory 1003 used for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The disclosure also provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiment of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

As used herein, the terms “machine-readable medium” and “computer-readable medium” refer to any computer program product, device, and/or equipment (e.g., magnetic disk, optical disk, memory, programmable logic device (PLD)) for providing machine instructions and/or data to a programmable processor, which includes a machine-readable medium that receives machine instructions as machine-readable signals. The term “machine-readable signal” refers to any signal used to provide machine instructions and/or data to a programmable processor.

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of such background components, middleware components, or front-end components. The components of the system may be interconnected by any form or medium of digital data communication (e.g., a communication network). Examples of communication networks include: a Local Area Network (LAN), a Wide Area Network (WAN), and the Internet.

The computer system may include a client and a server. The client and the server are generally remote from each other and interacting through a communication network. The client-server relation is generated by computer programs running on the respective computers and having a client-server relation with each other.

It is understandable that the steps can be reordered, added or deleted using various forms of processes shown above. For example, the steps in the disclosure may be performed in parallel, sequentially or in different orders, as long as the desired results of the technical solutions disclosed in the disclosure are achieved, which are not limited herein.

In addition, it should be understood that the embodiment of the disclosure can be implemented separately or in combination with other embodiments if it is allowed by the disclosure.

Those skilled in the art may realize that the units and algorithmic steps of the various examples described in combination with the embodiments of the disclosure disclosed herein are capable of being implemented in the form of electronic hardware, or a combination of computer software and electronic hardware. Whether these functions are performed in the form of hardware or software depends on the specific application and the design constraints of the technical solution. Those skilled in the art may use different methods to implement the described functions for each particular application, but such implementations should not be considered as beyond the scope of the disclosure.

It is clearly understood by those skilled in the art that for convenience and conciseness of description, the specific working processes of the systems, devices and units described above can be referred to the corresponding processes in the aforementioned method embodiments, and will not be repeated here.

The above are only specific implementations of the disclosure, but the scope of protection of the disclosure is not limited thereto. Those skilled in the art familiar to this technical field may easily think of changes or substitutions in the technical scope disclosed by the disclosure, which shall be covered by the scope of protection of the disclosure. Therefore, the scope of protection of the disclosure shall be governed by the scope of protection of the attached claims.

1. A communication method based on a distributed system, performed by a network device, comprising:
determining measurement configuration information, wherein the measurement configuration information comprises a measurement transmission reception point (TRP) identifier (ID) set, a measurement metric and a measurement parameter;
sending the measurement configuration information to a user equipment (UE);
sending reference signals of measurement TRPs which correspond to the measurement TRP ID set;
receiving an ID of a recommended TRP or an ID of a recommended TRP reference signal, wherein the recommended TRP is a measurement TRP meeting a condition and determined by the UE according to the measurement metric and the measurement parameter; and
determining at least one of a transmission TRP or a reception TRP for subsequent use, according to the ID of the recommended TRP or the ID of the recommended TRP reference signal.

2. The method of claim 1, wherein the measurement TRP ID set comprises at least one of:
IDs of the measurement TRPs;
resource IDs of the reference signals of the measurement TRPs; or
sequence IDs of the reference signals of the measurement TRPs.

3. The method of claim 1, wherein the measurement metric comprises at least one of: a signal to interference plus noise ratio (SINR), a reference signal receiving power (RSRP), a reference signal receiving quality (RSRQ) or a received signal strength indication (RSSI),
the measurement parameter comprises a range of arrival time and a reference signal quality threshold.

4. The method of claim 3, wherein the range of arrival time is a range within which an arrival time of the recommended TRP falls, and the arrival time comprises a single-path arrival time or a multi-path arrival time.

5. The method of claim 3, wherein the reference signal quality threshold is a minimum value that a receiving energy of a reference signal of a measurement TRP at the UE is able to meet.

6. The method of claim 1, further comprising:
receiving a measurement result of the recommended TRP, wherein the measurement result is a value of a measurement metric of a reference signal corresponding to the recommended TRP;
wherein determining at least one of the transmission TRP or the reception TRP for subsequent use, according to the ID of the recommended TRP or the ID of the recommended TRP reference signal, comprises:
determining at least one of the transmission TRP the reception TRP for subsequent use, according to the ID of the recommended TRP or the ID of the recommended TRP reference signal, and the measurement result.

7. The method of claim 1, further comprising:
indicating a threshold of a number of recommended TRPs to the UE.

8. A communication method based on distributed multiple input multiple output (MIMO), performed by a user equipment (UE), comprising:
receiving measurement configuration information sent by a network device, wherein the measurement configuration information comprises a measurement transmission reception point (TRP) ID set, a measurement metric and a measurement parameter;
receiving reference signals of measurement TRPs which correspond to the measurement TRP ID set sent by the network device;
determining measurement results of measurement metrics of the reference signals, and determining a measurement TRP that meets a condition as a recommended TRP according to the measurement results and the measurement parameter; and
sending an ID of the recommended TRP or an ID of a recommended TRP reference signal to the network device, wherein the recommended TRP is used for assisting the network device to determine at least one of a transmission TRP or reception TRP for subsequent use.

9. The method of claim 8, wherein determining the measurement results of the measurement metrics of the reference signals, and determining the measurement TRP that meets the condition as the recommended TRP according to the measurement results and the measurement parameter, comprise:
determining values of the measurement metrics of the reference signals as the measurement results; and
determining the measurement TRP that meets the condition as the recommended TRP according to the measurement results and the measurement parameter.

10. The method of claim 8, wherein the measurement parameter comprises a range of arrival time and a reference signal quality threshold,
a measurement TRP whose reference signal has an arrival time at the UE falling within the range of arrival time is determined as a candidate TRP; and
a candidate TRP whose measurement result is greater than or equal to the reference signal quality threshold is determined as the recommended TRP.

11. The method of claim 8, further comprising:
reporting a measurement result of the recommended TRP, wherein the measurement result is the value of a measurement metric of a reference signal corresponding to the recommended TRP.

12. The method of claim 8, further comprising:
receiving a threshold of a number of recommended TRPs indicated by the network device.

13. The method of claim 12, wherein determining the measurement TRP that meets the condition as the recommended TRP according to the measurement results and the measurement parameter, comprises:
in a case of the number of recommended TRPs is greater than the threshold, selecting a number of recommended TRPs that is less than or equal to the threshold according to measurement results of the recommended TRPs, and sending an ID of a selected recommended TRP or an ID of a selected recommended TRP reference signal to the network device.

14-15. (canceled)

16. A communication device, comprising: a transceiver, a memory and a processor connected to the transceiver and the memory, respectively, wherein the processor is configured to:
determine measurement configuration information, wherein the measurement configuration information comprises a measurement transmission reception point (TRP) identifier (ID) set, a measurement metric and a measurement parameter;
send the measurement configuration information to a user equipment (UE);
send reference signals of measurement TRPs which correspond to the measurement TRP ID set;
receive an ID of a recommended TRP or an ID of a recommended TRP reference signal, wherein the recommended TRP is a measurement TRP meeting a condition and determined by the UE according to the measurement metric and the measurement parameter; and
determine at least one of a transmission TRP or a reception TRP for subsequent use, according to the ID of the recommended TRP or the ID of the recommended TRP reference signal.

17. A non-transitory computer storage medium, wherein the computer storage medium stores computer executable instructions, and when the computer executable instructions are executed by a processor, the method of claim 1 is implemented.

18. A communication device, comprising: a transceiver, a memory and a processor connected to the transceiver and the memory, respectively, wherein the processor is configured to implement the communication method according to claim 8.

19. A non-transitory computer storage medium, wherein the computer storage medium stores computer executable instructions, and when the computer executable instructions are executed by a processor, the method of claim 8 is implemented.

20. The communication device of claim 16, wherein the measurement TRP ID set comprises at least one of:
IDs of the measurement TRPs;
resource IDs of the reference signals of the measurement TRPs; or
sequence IDs of the reference signals of the measurement TRPs.

21. The communication device of claim 16, wherein the measurement metric comprises at least one of a signal to interference plus noise ratio (SINR), a reference signal receiving power (RSRP), a reference signal receiving quality (RSRQ) or a received signal strength indication (RSSI),
the measurement parameter comprises a range of arrival time and a reference signal quality threshold.

22. The communication device of claim 21, wherein the range of arrival time is a range within which an arrival time of the recommended TRP falls, and the arrival time comprises a single-path arrival time or a multi-path arrival time.
